(19) United States
(12) Patent Application Publication
(10) Pub. No.: US 2007/0266406 A1
(43) Pub. Date: Nov. 15, 2007

(54) METHOD AND SYSTEM FOR PERFORMING ACTIONS USING A NON-INTRUSIVE TELEVISION WITH REDUCED TEXT INPUT

(76) Inventors: Murali Aravamudan, Windham, NH (US); Sankar Ardhanari, Windham, NH (US)

Correspondence Address: WILMER CUTLER PICKERING HALE AND DORR LLP, 60 STATE STREET, BOSTON, MA, 02109, US

(21) Appl. No.: 11/743,500

(22) Filed: May 2, 2007

Related U.S. Application Data
(63) Continuation-in-part of application No. 11/204,546, filed on Aug. 15, 2005.
(60) Provisional application No. 60/626,274, filed on Nov. 9, 2004.
(60) Provisional application No. 60/676,768, filed on May 2, 2005.
(60) Provisional application No. 60/797,234, filed on May 3, 2006.

(51) Int. Cl. G06F 3/00

(52) U.S. Cl. 725/57; 725/37; 725/38; 725/60

(57) ABSTRACT

A method of and system for performing actions using a non-intrusive television interface with reduced text input is provided. The method includes receiving incremental text input entered by a user that identifies desired items from within a relatively large search space. The method includes selecting and presenting a collection of items based on comparing the input with descriptive terms associated with the items, monitoring user selections, learning preferences of the user from the monitoring; and selecting a set of items based on comparing subsequent incremental text input entered by the user with the descriptive terms associated with the items. The method includes using a relevance function to order the set of selected items so that a relatively small number of highly relevant items may be identified and presented. The method presents the ordered results on a portion of a display device while simultaneously displaying television content on the display device.

### CROSS-REFERENCE TO RELATED APPLICATIONS

This application is a continuation-in-part of and claims the benefit under 35 U.S.C. §120 to U.S. patent application Ser. No. 11/204,546, entitled Method and System For Performing Searches For Television Content And Channels Using a Non-Intrusive Television Interface and With Reauced Text Input, filed Aug. 15, 2005, which claims priority to U.S. Provisional Application No. 60/626,274, entitled Television Systems and Associated Methods, filed Nov. 9, 2004, and U.S. Provisional Application No. 60/676,768, entitled A Non-Intrusive Television Interface to Search With Reduced Text Entry for Instant Content Availability and Rendering Desired Content, filed May 2, 2005; this application claims the benefit under 35 U.S.C. § 119(e) of U.S. Provisional Application No. 60/797,234, entitled Method And System For Performing Searches Using a Non-intrusive Television Interface With Reduced Text Input For Making a Phone Call Or Consummating A Transaction, filed May 3, 2006, all of which are herein incorporated by reference.

### BACKGROUND OF THE INVENTION

1. Field of Invention

The present invention generally relates to a method of and system for performing searches and actions using a television system as an interface, and more particularly, to a method of and system for performing searches through a television system for a phone number or a product and acting upon the desired result with minimal effort.

2. Description of Related Art

Television continues to remain an entertainment and information device in the home, although attempts have been made to use it as a user-driven information access device (e.g., WebTV, etc.). However, people still often go to their personal computers to search and purchase an item of interest or use a yellow page directory to find a person and make a call. This is mainly due to the fact that any such activity is subordinate to the television viewing experience, and an interface enabling search and performance of actions with minimal effort does not exist.

The absence of such an interface on a television system forces the user to adapt to other methods of discovering desired information and acting upon it. For example, when the user is watching a movie and would like to order pizza, the only option available now is to use a phone and order pizza after retrieving the phone number by some means, for example, by a PC based search, yellow page lookup, live directory assistance, etc.

A need exists for a non-intrusive television search interface that enables users to find desired content and/or information quickly and to easily act upon the desired result to perform an action or consummate a transaction. Such an interface would obviate the need for the user to go back to his or her personal computer or use a directory (e.g. yellow pages) to locate a phone number to make a call. Such an interface would also obviate the need for creating explicit favorites lists of repetitive activities.

### BRIEF SUMMARY OF THE INVENTION

The invention provides methods of and systems for performing actions using a non-intrusive television interface with reduced text input.

Under another aspect of the invention, a method of non-intrusively selecting an item presented on a display device from a relatively large search space, the items being associated with descriptive terms that describes the items includes a content system receiving incremental text input entered by a user. The incremental text input incrementally identifies desired items from within the relatively large search space. The method also includes the content system selecting and presenting a collection of items based on comparing the incremental text input entered by the user with the descriptive terms associated with the items, the content system monitoring user selections of items, the content system learning preferences of the user from the monitoring of user selections; and the content system selecting a set of items based on comparing subsequent incremental text input entered by the user with the descriptive terms associated with the items. The method further includes using a relevance function to order the set of selected items so that a relatively small number of highly relevant items may be identified. The relevance function causes preferred items to be presented as more relevant items. The method also presents the ordered results on a portion of a display device while simultaneously displaying television content on the display device. The portion of the display device occupies a relatively small fraction of the area of the display device, thereby enabling the relatively small number of highly relevant items to be displayed non-intrusively with the simultaneously displayed television content.

Under another aspect of the invention, the item is an action for initiating an exchange of information with an entity associated with the action, the descriptive terms associated with the action characterizes the entity associated with the action, and the incremental text inputs incrementally identify desired actions or associated entities.

Under a further aspect of the invention, the action can be a telephone call placed to the associated entity, and/or the action can be a purchase of an article from the associated entity.

Under yet another aspect of the invention, the relevance function includes at least one of temporal relevance to compare the time of day to a known time of availability of the item and a popularity relevance to specify a general popularity rating for the item.

Under another aspect of the invention, the order is transmitted to the entity via an IP network connection. The order can include information that identifies at least one of the user, shipping information of the user, and billing information of the user.

Under yet a further aspect of the invention, the portion of the display device is overlaid on television content currently playing on the display device. The portion of the display device can include at least parts thereof that are translucent, thereby allowing said television content currently playing on the display device to be at least partially visible to the user through the translucent parts of said portion of the display device.

Under another aspect of the invention, a system for non-intrusively selecting an item to be presented on a display device from a relatively large search space is capable of performing the functions described above.

These and other features will become readily apparent from the following detailed description wherein embodiments of the invention are shown and described by way of illustration.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 illustrates a network based information navigation system.

FIG. 2 illustrates device configuration options to perform navigation of locally or remotely resident information.

FIG. 3 illustrates an example of a non-intrusive interface for content and channel searching with an illustrative user text input.

FIG. 4 illustrates a screen shot of an illustrative non-intrusive interface.

FIG. 5 illustrates the non-intrusive interface of FIG. 3 with a different illustrative user text input.

FIG. 6 illustrates a non-intrusive interface with results returned for a single character query input.

FIG. 7 illustrates a non-intrusive interface and remote control for searching for information and acting upon retrieved results, while enabling simultaneous viewing of television content.

FIG. 8 illustrates the interface of FIG. 7, where a user is prompted with a phone call action associated with a search result.

FIG. 9 is a flow chart of a user inputting text incrementally, finding results and acting upon discovered results.

FIG. 10 illustrates the various states a user can traverse in order to get to a desired result.

FIG. 11 is a flow chart illustrating the process of a user selecting context specific actions performed on a selected content link.

FIG. 12 illustrates examples of the various actions a user can perform on a desired result.

Like reference numerals generally refer to like elements in the drawings.

### DETAILED DESCRIPTION OF THE INVENTION

Embodiments of the present invention provide for retrieving results and actions to be performed with very little user input and presenting the results on a non-intrusive interface. The non-intrusive interface occupies a proportionately small space on a television screen. Because the results presentation area imposes a tight constraint on the number of results that can be shown, the system optimally orders the results based on a relevance function. This enables the user to discover the results easily and act upon a desired result with minimal effort, such as, for example, a one-click telephone call or transaction consummation. In addition, the search, discovery, and performance of the action are able to occur while the user is viewing content on the television system.

For example, the system enables a user to enter a search query for “pizza” using the non-intrusive interface while watching a movie. The system responds by presenting relevant results with the phone numbers, from which the user picks one result. When the user selects the “call” action associated with the result, a telephone call is set-up between the pizza store and the user. Furthermore, the search can be a personalized incremental search, which enables the user to find pizza restaurants without requiring the user to enter the full term “pizza”. As described in more detail below, the number of characters used to discover “pizza” would reduce over time as the system learns the user's repetitive behavior and general preferences.

Embodiments of the present invention build on techniques, systems and methods disclosed in earlier filed applications, including but not limited to U.S. patent application Ser. No. 11/136,261, filed on May 24, 2005, entitled Method and System For Performing Searches For Television Content Items Using Reduced Text Input, U.S. patent application Ser. No. 11/204,546, filed on Aug. 15, 2005, entitled Method and System For Performing Searches For Television Content And Channels Using a Non-Intrusive Television Interface and With Reduced Text Input, U.S. patent application Ser. No. 11/246,432, filed on Oct. 7, 2005, entitled Method and System For Incremental Search With Reduced Text Entry Where the Relevance of Results Is a Dynamically Computed Function of User Input Search String Character Count, U.S. patent application Ser. No. 11/235,928, filed on Sep. 27, 2005, entitled Method and System For Processing Ambiguous, Multiterm Search Queries, and U.S. patent application Ser. No. 11/246,432, filed on Oct. 7, 2005, entitled Methods and Systems For Selecting and Presenting Content Based On Learned Periodicity Of User Content Selection, the contents of which are herein incorporated by reference in their entirety. Those applications taught techniques, methods, and systems for performing searches using incremental input, use of non-intrusive interfaces for television content searches, result set ordering functions, and learning user preferences. The present techniques, however, are not limited to systems and methods disclosed in the incorporated patent applications. Thus, while reference to such systems and applications may be helpful, it is not believed necessary to understand the present embodiments or inventions.

When a television viewer initiates a search, the viewer is provided with a non-intrusive interface on a television display. The non-intrusive interface preferably only occupies a small space on the television display. The non-intrusive interface is preferably overlaid on the content item being currently viewed, thereby enabling the user to watch an existing program on television while initiating a search for information or performing an action through the interface. The viewer can, using the non-intrusive interface, input a reduced text search entry directed at identifying desired information such as content to view or transactions to perform. The reduced text search entry comprises one or more characters of a descriptor relating to the information being searched (e.g., a word prefix, an acronym, or an abbreviation). The search system dynamically identifies a group of one or more items matching the search entry as the television viewer enters each character of the reduced text search entry (e.g., as described in U.S. patent application Ser. Nos. 11/136,261 and 11/235,928 incorporated above). The search results include, for example, actions to be performed, television channels, television shows, movies, music videos, audio programs, and other audio/video content, which are displayed to the viewer on the non-intrusive interface. The results are preferably ordered based on given criteria such as temporal relevance, geographic relevance, popularity and personal preferences, where user preferences are implicitly learned over time from the actions performed by the user (e.g., as described in U.S. patent application Ser. No. 11/246,432 incorporated above). The user can navigate through the search results, and after the user has found and selected a desired item, the user can act upon the result with very minimal effort.

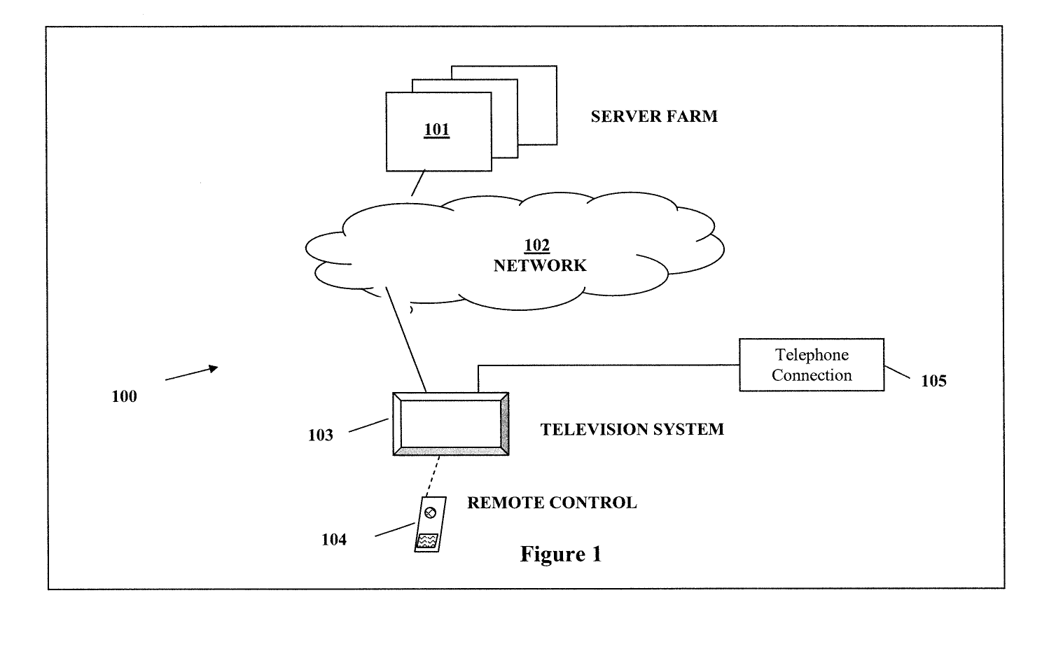

FIG. 1 schematically illustrates an overall system 100 that can be used for performing a search for content or information, for example, television channels, television content, phone numbers, and/or products in accordance with one or more embodiments of the invention. The system includes a server farm 101, a network 102, and a plurality of television systems 103 operated by television viewers (i.e., television users). The server farm 101 processes search queries and is the source of search data and relevance updates. The server farm 101 can also be the source of or be linked to a source of at least some of the available television content, phone book information, performable transaction, or other information (e.g., a cable company, telephone company, or satellite television operator). The network 102 functions as the distribution framework for transmitting data from the server farm 101 to the televisions. The distribution network 102 can be a wired or wireless connection or some combination thereof. Examples of possible networks include cable television networks, satellite television networks and IP-based television networks. Users can view content on the television systems 103 connected to the distribution network 102. The system 100 may also include a telephone connection 105, described in greater detail below.

The server farm 101 can contain content data in a form compatible with the reduced text search techniques. For example, the techniques, systems, and methods disclosed in U.S. patent application Ser. No. 11/136,261, incorporated above, may be used to populate a content database for use with the present invention. The raw content, convertible to the compatible form, may be provided, for example, by various commercial sources, such as product and service vendors, telephone books, or the raw content may be compiled from information available on the Internet.

Each system includes a search system that allows users to find desired content, television channels, and/or other information. The search system includes a text input interface, which is preferably a remote control device 104 having a keypad or keyboard through which the user can enter text. The text input interface can also be a keypad on the television unit or a set-top box or other device connected to the television. The text input interface will typically include a keypad having a limited set of keys that are overloaded with multiple characters and numbers (such as a mobile telephone keypad). By way of example, one button could be associated with the number “2” and the letters “A”, “B”, and “C”. Other examples of overloaded keyboard systems that can be used with the present invention are described in the incorporated applications.

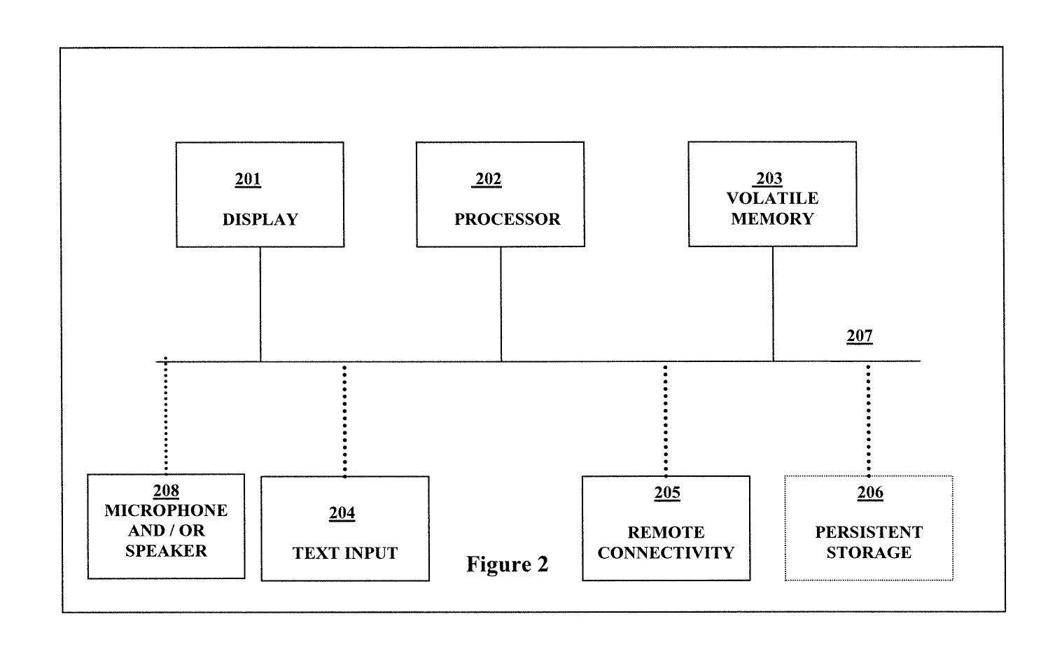

FIG. 2 illustrates illustrative device configurations for performing searches in accordance with one or more embodiments of the invention. In one configuration, the television system 103 a has display 201, a processor 202, volatile memory 203, a text input interface 204, remote connectivity 205 to the server farm 101 through the network 102, and a persistent storage 206.

In another possible device configuration, the television system 103 might not have local persistent storage 206. In such a configuration, the device 103 can use remote connectivity 205 to submit the query to a server farm 101 and retrieve results from it.

In a configuration of the television system with remote connectivity 205 and persistent storage 206 for searching, the device may use the remote connectivity for search relevance data update. In addition, the television system may use the remote connectively 205 where the search database is distributed between the local storage 206 and the server 101.

A television system 103 can have a set-top box with a one-way link to a satellite. In this configuration, all search data, including relevance updates, may be downloaded to the device through the satellite link to perform local searches. Relevance updates can be periodically done through this one-way link.

The system can have remote connectivity 205 that allows two-way communication with the server farm 101 through the distribution network 102. The remote connectivity 205 can also connect to other networks (not shown). Similarly, the system can have a telephone connection 105 for facilitating two-way communication outside the system 100. The telephone connection 105 can be, for example, a connection to a traditional telephone line or a voice over IP interface. Some embodiments may have a microphone and/or speaker 208 allowing a user to conduct a phone call through the system using the telephone connection 105.

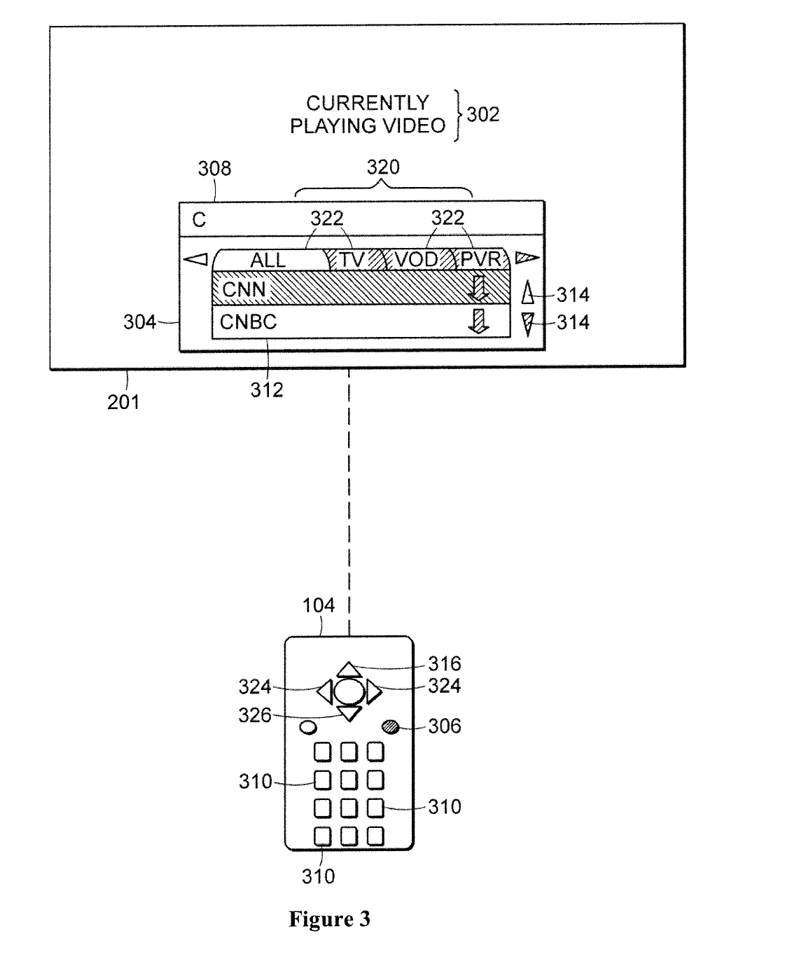

FIG. 3 illustrates a non-intrusive search interface 304. The television system 103 includes the display screen 201 having a program or some content 302 currently playing on the screen. The user can initiate or launch the non-intrusive search interface 304 on the display screen 201. The remote control device 104 used to operate the television includes a shortcut key 306 to engage the non-intrusive interface 304. The non-intrusive interface 304 is overlaid on top of the television content 302 playing on the screen. It occupies only some (preferably only a small area) of the area of the screen, so that a viewer can still see the program playing on the screen. The interface is considered “non-intrusive” in that the viewer can continue to at least partially view content currently playing on the television display while conducting a search for other content or channels.

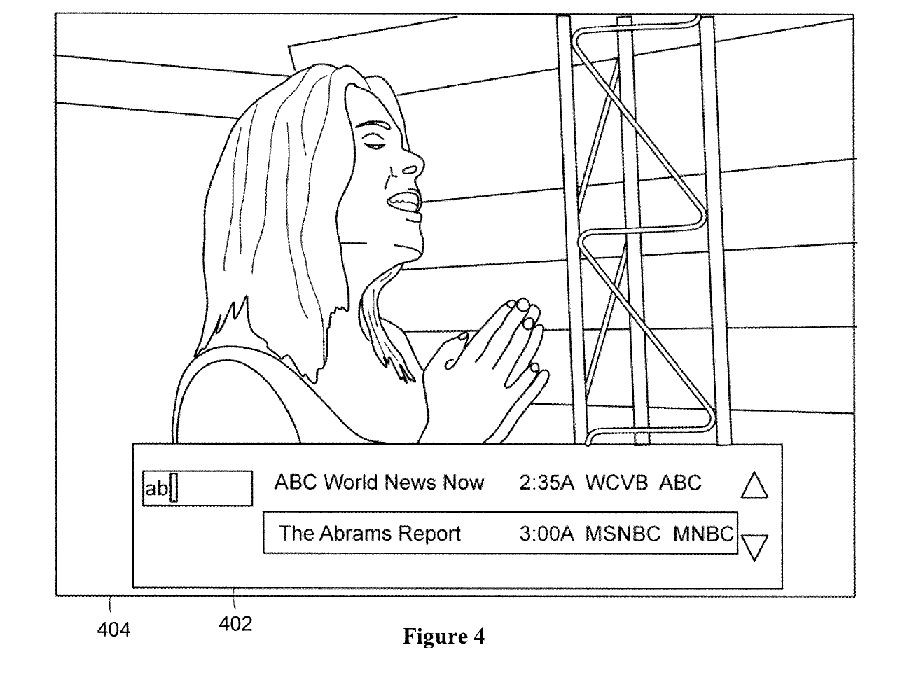

In addition, the interface 304 is preferably at least partially translucent or semi-transparent, allowing the television content playing on the screen over which the interface is overlaid to be at least partially visible through the interface. Translucent or semi-transparent images can be achieved by alpha-blending or similar techniques. Another example of a non-intrusive interface 402 is shown in FIG. 4, which is a screenshot of a television display 404 having the non-intrusive translucent interface 402 overlaid on a program playing on the television. Various other alternative non-intrusive interfaces are also possible that allow users to initiate searches while being able to continue observing at least a portion of the content being displayed on the screen including e.g., interfaces overlaid on the program being played, in which the characters displayed in the interface are opaque or otherwise easily visible. Other examples of non-intrusive interfaces include interfaces that are displayed on one portion of the screen while content is being displayed on another portion of the screen.

The non-intrusive interface 304 shown in FIG. 3 includes a text entry field 308, in which users can enter text for a search using the text entry buttons 310 of the remote control device 104. The non-intrusive interface 304 also includes a results window 312, in which the results of a search are displayed. As shown in the FIG. 3 example, when the user has entered one character “C” in the text entry field 308, the results of the search include the TV channels, “CNN” and “CNBC” which are displayed in the results window 312. Only a given number of the results (e.g., in FIG. 3, there are two) are displayed at a time. The user can scroll down using the vertical navigation interface 314 using the vertical navigation buttons 316, 326 on the remote control 104 to see additional results that were not initially displayed in the results window.

The results of the search are preferably ordered in the results window 312 to reflect what is expected to be of greater interest to the viewer. Different criteria can be used to determine the ordering. The ordering of results is one of or a combination of two or more of: temporal relevance, popularity and personal preferences that may have been determined implicitly or explicitly. Temporal relevance can be used to favor programs whose timing may be more of interest to the viewer. For example, if the user entered NBA, then the system would list the games in order of temporal relevance, for example, those in progress or those scheduled to begin in the near future are listed higher on the list. The popularity criterion can be used to favor programs or channels that are more popular than others. The personal preference criterion can be used to favor programs or channels that the user has indicated preference for in prior user selections. For example, if a user frequently scrolls down to “CNBC” and selects it, the system would over time place CNBC higher in the list of results over a more generally popular channel such as CNN. Furthermore, identity independent time-based usage pattern learning algorithms can be applied in conjunction with personalization to apply the results ordering rules in an appropriate context.

The FIG. 3 non-intrusive interface 304 optionally includes a search space filter interface 320 to filter results in accordance with particular sources of or particular types of content (e.g., television, VOD, PVR, and IPTV). The interface includes a set of tabs 322 associated with the sources or types of content. A user can, if desired, select one of the tabs 322 to limit the search results to a particular source or type of content of interest. The semantics of navigating the horizontal tabs using the horizontal navigation buttons 324 on the remote control device 104 is content specific and is also determined by the search string.

Further information related to a selected program or channel can be displayed on the non-intrusive interface 304 if desired. For example, if the TV tab is selected, then navigating horizontally after selecting one of one of the channels in the results window, could display the immediately following program. If the user had searched for a cast member (e.g., Tom Cruise), horizontal navigation could be used by the viewer to, e.g., navigate through all available programs that contain that cast member.

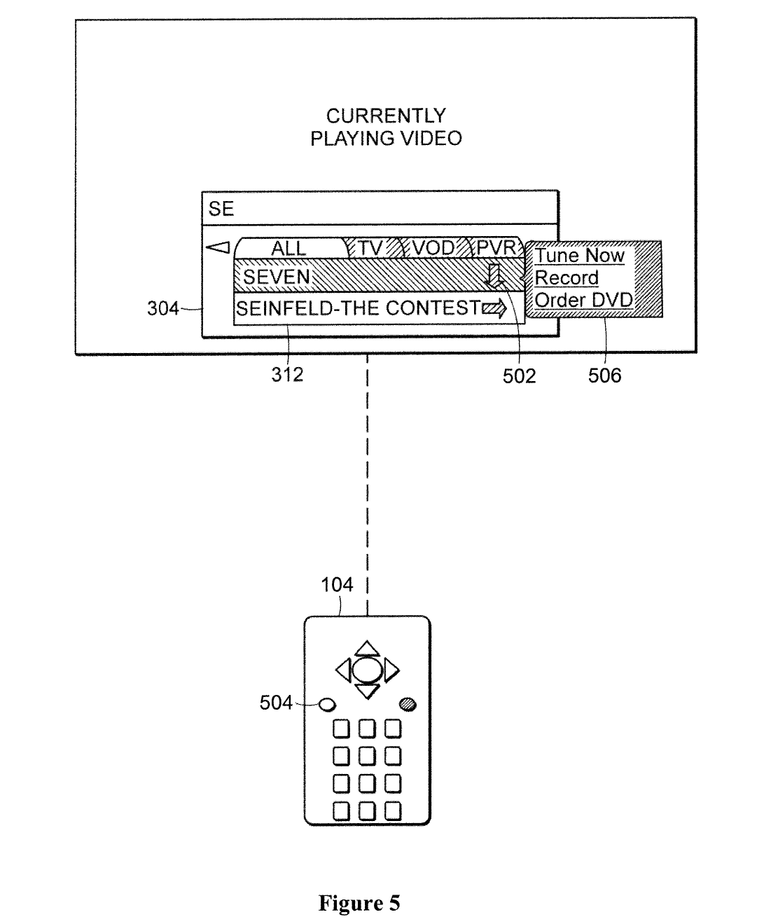

In the example illustrated in FIG. 5, after the user enters the string “SE”, two results are dynamically displayed in the visible results window: the first one being the movie “SEVEN”, which could be a VOD source, and the second one the TV serial “SEINFELD”. Visual cues can be provided adjacent to the results to indicate the availability of the content. In this example, for the case of Seinfeld, an icon 502 (a shaded downwardly pointed arrow) is provided to indicate that the program will be on shortly. The user can then be given the choice to either directly initiate a recording of the program by clicking a “record” button 504 (commonly available on remote control devices) after scrolling to that result or by selecting the record action from an “actions menu” 506 obtained by selecting the result as shown in FIG. 5. The “actions menu” 506 can also provide an option to the user to set a reminder to notify the user when the show will be on. Additionally, the user could horizontally navigate to see if there is an equivalent or similar category program available now from any of the content sources.

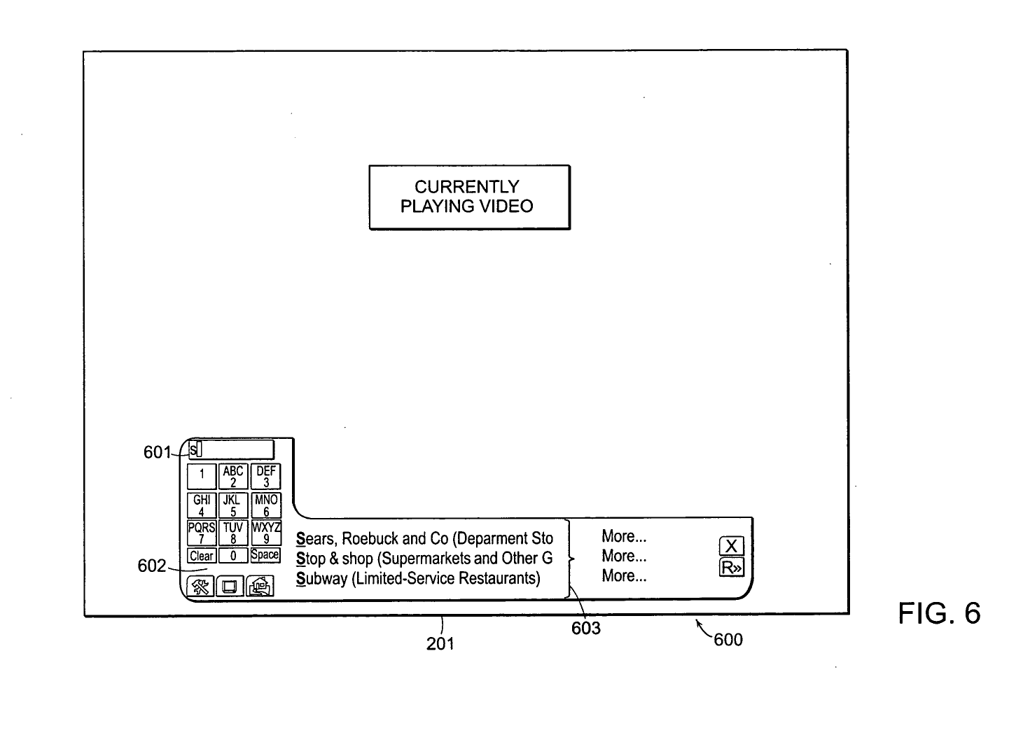

FIG. 6 illustrates another example of a non-intrusive search interface 600 that occupies a small portion of the television screen. The user enters characters constituting a search query using a virtual keypad 602. The results are displayed in a search input area 601 as user types in each character. In the FIG. 6, the user has entered the character “s”, which yields results 603 that are relevant to the search input and to the user in terms of the time of search, the location of the search, and the user's prior action history.

As described above, the image rendered on the television screen may be generated locally or remotely using techniques known in the art. The navigation of the interface may adopt techniques, methods and systems disclosed in U.S. patent application Ser. No. 11/509,909, filed Aug. 25, 2006, entitled User Interface For Visual Cooperation Between Text Input and Display Device, the contents of which are herein incorporated by reference in its entirety. However, these methods are not required, and other methods of navigating the on-screen image may be used.

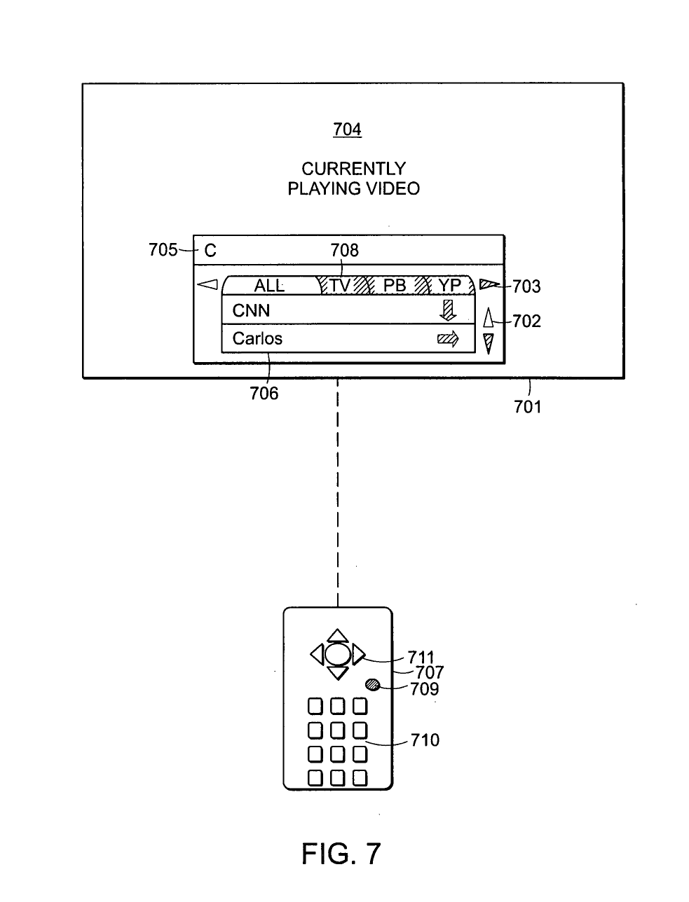

FIG. 7 shows another illustrative non-intrusive interface 701, where text input 705 yields results 706. The non-intrusive interface 701 appears on the screen along with currently playing video content 704. The results can be filtered with different filters 708, such as “ALL”, to show all data, “TV to show only television content, “PB” to show telephone book entries, and “YP” to show yellow page entries. Additional filter sections can be accessed via scroll button 703. The user can scroll up and down the list of results using scroll buttons 702. Remote control 707 can have a keypad with overloaded keys 710 and can also include a five button navigation control 711. The remove control can include additional features, such as a quick-launch search button 709.

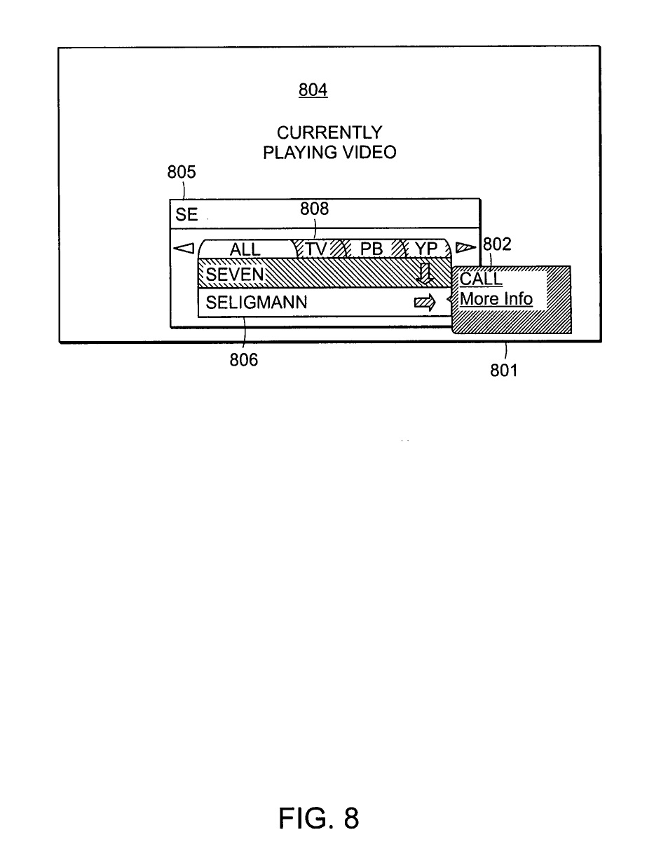

FIG. 8 shows illustrative action 802 that can be performed on a result. For example, the user can enter the search string “SE” into search input area 805 and call “Seligmann” with just the click of a button. The power of incremental search, combined with a non-intrusive interface 806 enables the user to quickly and easily perform the telephone call while simultaneously viewing video content 804 on television system 801. Placing a telephone call is only one example of a possible action the user can perform. For example, the action 802 can also be a purchase of a product, where a commercial transaction is consummated for the purchase of a product retrieved by the incremental search, using the non-intrusive interface 806.

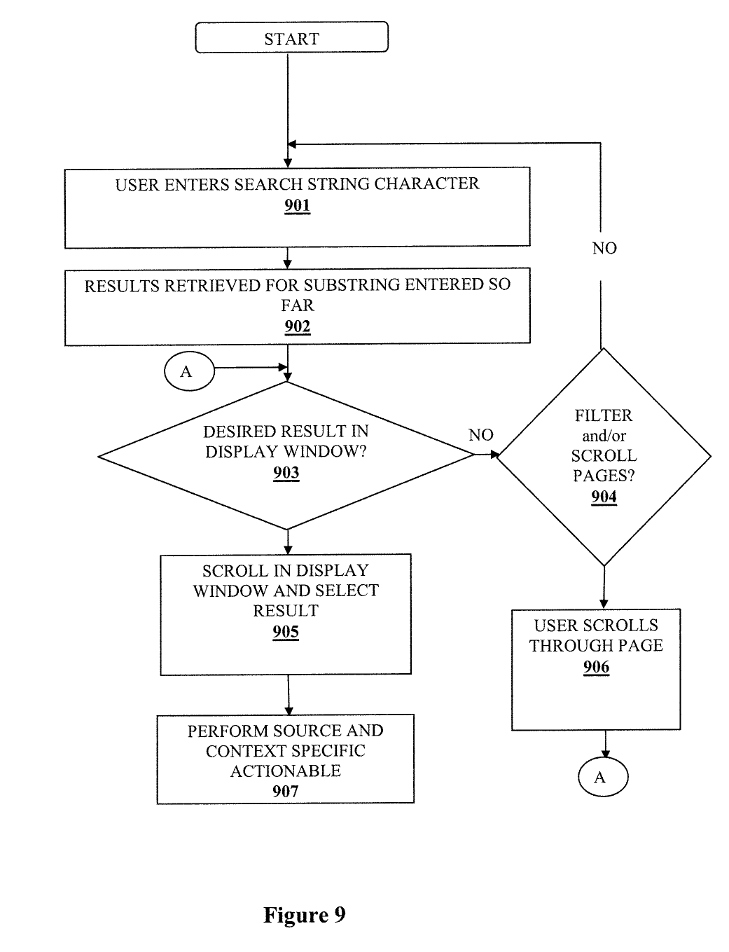

FIG. 9 illustrates a process of searching for television content, actions, transactions, or other items in accordance with one or more embodiments of the invention. A user initially enters a search string character at (step 901), which is a reduced text input representation of the content, channel, contact information, or information related to a transaction desired by the user. The reduced text input could be, for example, a variable size prefix or an acronym or other abbreviation of the intended query (e.g., S to represent Sears, BA to represent Banana Republic etc.). Results are dynamically retrieved for the cumulative substring of characters entered up to that point (step 902) and displayed in the display window of the user interface at (step 903). Techniques disclosed in U.S. patent application Ser. No. 11/136,261, incorporated above, provide particular methods of dynamically retrieving results as the user enters each character of a reduced text substring of characters, which may be used with embodiments of the present invention.

As indicated above, the ordering of results in the display window is preferably based on a relevance function that can, for example, be a domain specific combination of temporal relevance, location relevance, popularity, and user's personal preferences which are determined over time by user's action history (see the applications incorporated above for examples of specific techniques). If the result desired by the user is displayed in the results window at (step 903), the user can scroll to the desired result within the displayed window and select the desired result (step 905). If the desired result is the first entry in the display window, it may be selected by default, thus obviating the need to scroll through the display window.

If the desired result is not in the display window (step 903), the user can decide whether to filter the results (step 904) using content source tabs 808 (shown in FIG. 8) to narrow the results and/or whether to scroll through pages of results not initially displayed in the display window. After the user performs filtering and/or scrolling (step 906), the user again determines whether the desired result is in the display window (step 903). If the user chooses not to filter the results or to scroll through pages of results (step 904), he or she can continue to add new characters to the search string (step 901) to obtain further search results.

The dynamic updating of results as each character is entered enables the user to quickly get to the results, in contrast to discovering there are no matching results after typing the entire search text. Furthermore, the system learns the user's behavior and preferences, particularly repetitive behavior over time, to get desired results with progressively lesser number of characters. Once the user finds the desired result, it can be selected (step 907) to initiate the action that is appropriate to the selection. For example, an action can be a book purchase, finding a store, consummating a transaction, placing a telephone call, or other appropriate action.

In at least one implementation, upon the user initiating an action, the system takes appropriate steps to complete the action. These steps can include sending a request via the network 102 or telephone connection 105 (of FIG. 1). For example, if a user searches for and discovers telephone numbers for pizza delivery services, the user may initiate a telephone call to one of the services. In response, the system may dial a number via the telephone connection 105 to the pizza delivery service and simultaneously cause the user's telephone to ring, thereby connecting the user to the pizza delivery service to fulfill the user's pizza order using the user's telephone system.

Alternatively, the system may be equipped with a microphone and speaker 208 (of FIG. 2). In this implementation, the system would dial the telephone number discovered from the user's search, and connect the telephone call directly to the microphone and speaker 208. Thus, the user may interact with the system in a manner similar to a speakerphone so as to order a pizza for delivery. The microphone and speaker 208 may be located, for example, in a set-top box, the television, or may be incorporated in remote control 707 (of FIG. 7).

In some embodiments, the system can complete the user-initiated action through the remote connectivity 205. For example, the system may place an order for a user-discovered good or service through an IP connection to a vendor's server. The order can include information that identifies the user, including shipping and billing information, transmitted in a secure manner (e.g., using secure transmission techniques known in the art). This information can be supplied to the system via system-enabled configuration options.

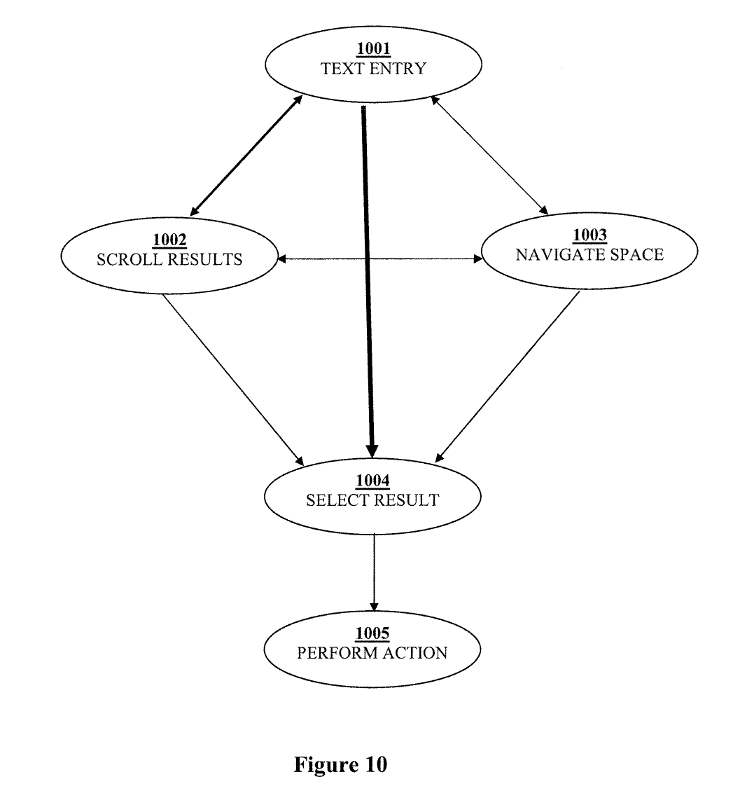

FIG. 10 illustrates possible state transitions to arrive at a result by reduced text entry. The generally minimal path for arriving at a desired result occurs when a user enters one or a few characters (step 1001), which identifies the desired result and presents the result in the visible display window, with the desired result already highlighted. The user would only have to select the result (step 1004) and act on the desired content (step 1005). After the user's general and specific preferences have been learned by the system, based on repeated user actions, the system will eventually converge on this ideal path. For example, the user may discover and act upon “Pizza hut” by first entering the string, “pizza h”. Over time, as the user repeats this behavior, the string the user needs to enter progressively reduces to “pizza”, “pizz”, “pi”, and finally p”. This reduction is determined by the frequency of this particular action in relation to other actions the user performs. In addition, the temporal and geographic location context in which the user performs this query is taken into account. Thus, in accordance with various embodiments of the invention, a user can choose content from a large space with simplicity and ease.

As mentioned above, the techniques, methods and systems disclosed in U.S. patent application Ser. No. 11/682,693, incorporated above, Ser. No. 11/682,588, filed Mar. 6, 2007, entitled Methods and Systems For Selecting and Presenting Content On A First System Based on User Preferences Learned On a Second System, and Ser. No. 11/682,695, filed Mar. 6, 2007, entitled Methods and Systems for Selecting and Presenting Content Based on User Preference Information Extracted From an Aggregate Preference Signature (all herein incorporated by reference in their entirety), may also be used with embodiments of the present invention for dynamically updating results based on a user's past searches and actions. However, the techniques disclosed in those applications are not necessary to practice the present invention.

When the desired result is not the first selection or is not visible in the results window, the user can scroll through the results (step 1002) or alternatively apply a filter to cull the results space. In at least one implementation, the interface displays the number of results for a given search entry. This can give the user a visual cue to use the filter when the results space is large. A filter can be chosen by default as a consequence of personalization. In addition, the user can directly navigate the search space (step 1003). In such as case, the search space can be organized in a tree-like hierarchy.

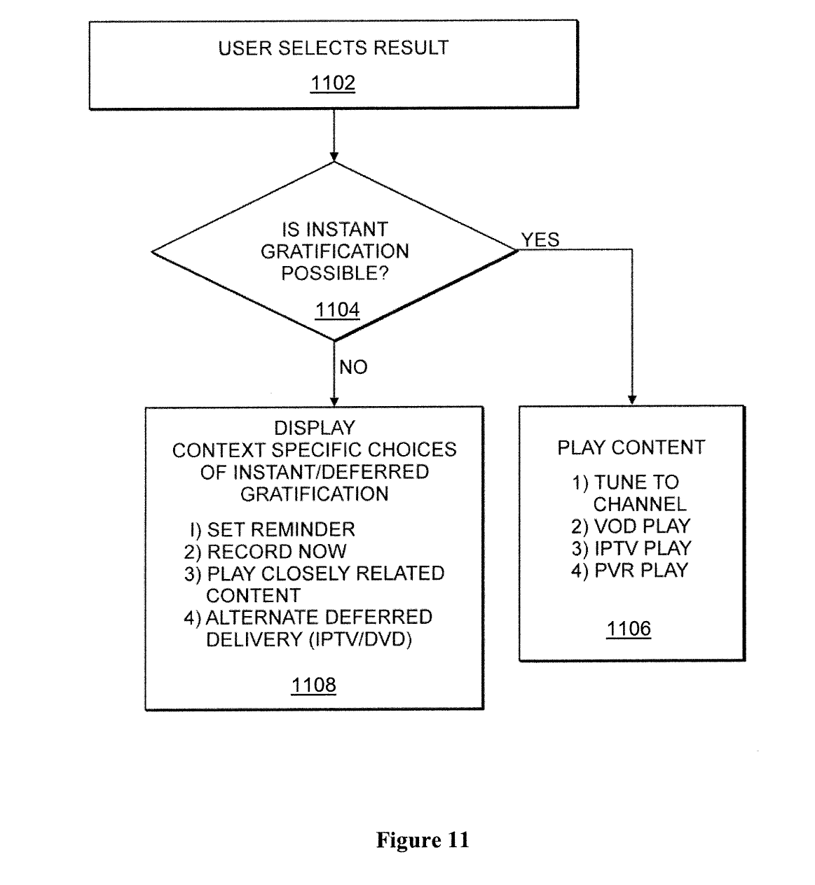

FIG. 11 illustrates the steps involved in performing an action responsive to a selection of a search result made by the user. Once the user has selected a result in the results window at 1102, the user determines at 1104 whether the selected content is currently available for viewing. If so, a set of context specific choices are displayed to the viewer at 1106 to play the content. In the case of a channel selection or a television program that is being currently broadcast, the action may be tuning to the channel directly. Alternatively, a VOD, IPTV, or PVR content fetch can be initiated for content that is instantly available and the fetched content is rendered. When the content is not available, the system can at 1108 provide alternate choices for closely related content that is instantly available.

If the content is available on TV in the near future, the user is provided an option to initiate recording of the content. Additionally, the user may wish to record the content even if it is currently available. This would allow the viewer to record that content and, e.g., view some alternative program now. When the content is neither currently available or available in the near future, the user can also be given the option to procure the content in alternate forms, such as, e.g., on a DVD (if available on DVD). In this regard, the system may automatically place an order for the DVD with a merchant such as, e.g., Amazon.com, or a DVD rental company such as, e.g., Netflix.com. It should be noted that the various content specific choices for near and deferred gratification are not mutually exclusive. For example, user may choose to both record a program and order a DVD for that program. If the user is not able to find desired content, he or she can be given a choice to transition to a full screen search to perform a more elaborate search for content.

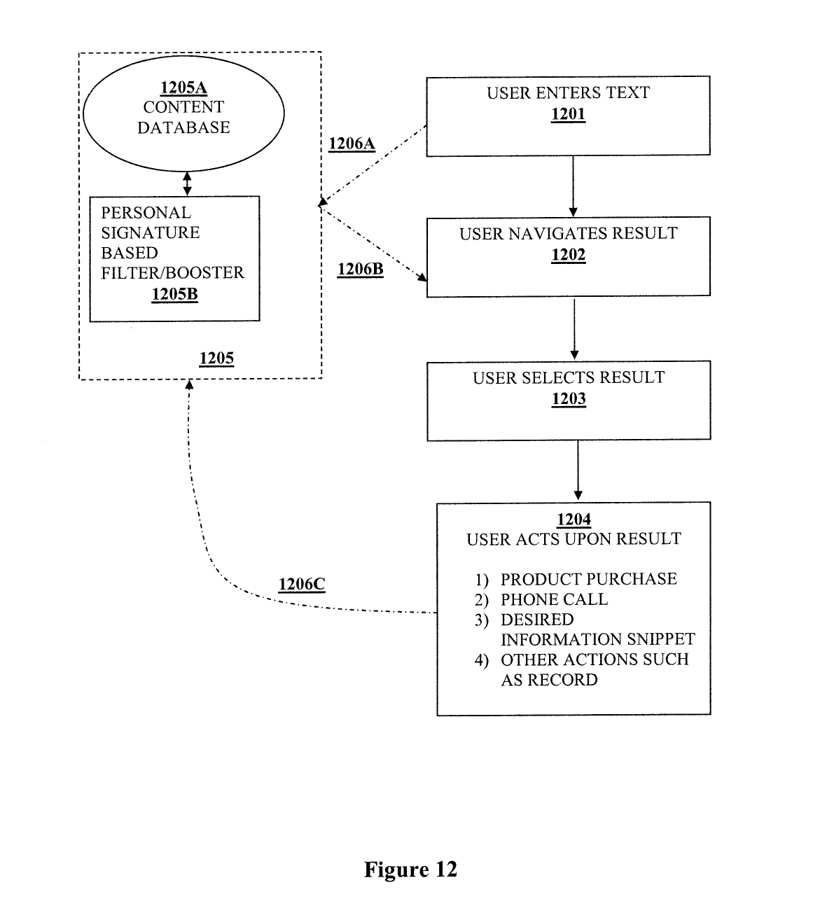

FIG. 12 illustrates another example of a possible process flow of the system learning the user's behavior and using a feedback mechanism to reduce the effort involved in a subsequent discovery of desired results. As the user enters text (step 1201), the query is sent to a search system 1205 (step 1206A). The results are returned (step 1206B), and the user navigates to the desired result (step 1202) and selects it (step 1203). The selection action causes the system to present a meaningful set of actions corresponding to the selected result, from which the user selects (step 1204). For example, in the case of a product such as a book, the action can be purchase of the book. In the case of a phone number, the action can be to place a phone call. In cases where there is only one meaningful or most likely action, that action can be initiated just by selection of the result (step 1203). The system provides feedback (step 1206C) to the search system based on the action the user performed. This is used to filter and/or reorder subsequent search results (step 1205B) when results are retrieved from a content database 1205A during a subsequent search.

In one implementation, the interface can be a full screen intrusive interface with minimal text entry and single- or multi-click actions for discovered results. The challenges of text input and limited display remain even in the case of a full screen display on a television; hence, embodiments of the invention are useful for full screen television interfaces as well.

It will be appreciated that the scope of the present invention is not limited to the above-described embodiments, but rather is defined by the appended claims, and these claims will encompass modifications of and improvements to what has been described. For example, the embodiments provided above are described in terms of television systems. However, the techniques, methods, and systems described and incorporated herein can be implemented as a non-intrusive or full-screen search interface on a mobile device, for example, a PDA or mobile telephone. These types of devices share many of the same constraints as those described for television systems, and thus, can benefit from aspects of the invention provided herein. Similarly, television content also encompasses any audio and/or video entertainment content that can be presented on the devices described above.

What is claimed is:

1. A method of non-intrusively selecting an item presented on a display device from a relatively large search space, the items being associated with descriptive terms that describes the items, the method comprising:
a content system receiving incremental text input entered by a user, said incremental text input incrementally identifying desired items from within the relatively large search space;
the content system selecting and presenting a collection of items based on comparing the incremental text input entered by the user with the descriptive terms associated with the items;
the content system monitoring user selections of items;
the content system learning preferences of the user from the monitoring of user selections;
the content system selecting a set of items based on comparing subsequent incremental text input entered by the user with the descriptive terms associated with the items;
using a relevance function to order the set of selected items so that a relatively small number of highly relevant items may be identified, wherein the relevance function causes preferred items to be presented as more relevant items; and
presenting the ordered results on a portion of a display device while simultaneously displaying television content on the display device, said portion of the display device occupying a relatively small fraction of the area of the display device, thereby enabling the relatively small number of highly relevant items to be displayed non-intrusively with the simultaneously displayed television content.

2. The method of claim 1, wherein the item is an action for initiating an exchange of information with an entity associated with the action, the descriptive terms associated with the action characterizing the entity associated with the action, and the incremental text inputs incrementally identifying desired actions or associated entities.

3. The method of claim 2, wherein the action is a telephone call placed to the associated entity.

4. The method of claim 3, wherein the content system places the telephone call to the associated entity and connects the telephone call to a telephone system proximate to the user.

5. The method of claim 2, wherein the action is a purchase of an article from the associated entity.

6. The method of claim 2, further comprising displaying on said portion of the display device visual cues to inform the user of the availability of actions for instant and deferred performance.

7. The method of claim 1, wherein the relevance function includes at least one of temporal relevance to compare the time of day to a known time of availability of the item and a popularity relevance to specify a general popularity rating for the item.

8. The method of claim 1, further comprising receiving from the user a selection action of one of the ordered results.

9. The method of claim 8, further comprising the content system performing the selection action, wherein the selection action comprises transmitting an order to the associated entity to purchase an article.

10. The method of claim 9, wherein the order is transmitted to the entity via an IP network connection.

11. The method of claim 9, wherein the order includes information that identifies at least one of the user, shipping information of the user, and billing information of the user.

12. The method of claim 1, wherein said portion of the display device is overlaid on television content currently playing on the display device.

13. The method of claim 12, wherein said portion of the display device includes at least parts thereof that are translucent, thereby allowing said television content currently playing on the display device to be at least partially visible to the user through the translucent parts of said portion of the display device.

14. The method of claim 1, wherein said portion of the display device includes a field for entry of at least one of the incremental text inputs and a window for displaying a given number of the set of selected items.

15. The method of claim 1, further comprising filtering the set of selected items in accordance with a source or category of the items and displaying filtered items in said portion of the display device.

16. The method of claim 1, further comprising providing to the user through said portion of the display device information related to the selected item.

17. The method of claim 1, wherein the method is implemented in a device included in or proximate to a television set.

18. The method of claim 1, wherein selecting the set of items is performed by a server system remote from the user in communication with a device included in or proximate to a television set.

19. The method of claim 1, further comprising enabling the user to scroll through additional items of the selected set by displaying identification of the additional items when directed by the viewer.

20. The method of claim 1, wherein the user enters at least one of the incremental text inputs on a remote control device having keys overloaded with two or more characters.

21. A system for non-intrusively selecting an item to be presented on a display device from a relatively large search space, the system comprising:
a catalog of the relatively large search space of items, the items being associated with descriptive terms that describe the informational content of the items,
a receiving logic for receiving incremental text input entered by a user, said incremental text input incrementally identifying desired items from within the catalog of the relatively large search space of items;
a first selection logic for selecting and presenting a collection of items based on comparing the incremental text input entered by the user with the descriptive terms associated with the items;
a monitoring logic for monitoring user selections of items;
a learning logic for learning preferences of the user from the monitoring of user selections;
a second selection logic for selecting a set of items based on comparing subsequent incremental text input entered by the user with the descriptive terms associated with the items;
an ordering logic for using a relevance function to order the set of selected items so that a relatively small number of highly relevant items may be identified, wherein the relevance function causes preferred items to be presented as more relevant items; and
a presentation logic for presenting the ordered results on a portion of a display device while simultaneously displaying television content on the display device, said portion of the display device occupying a relatively small fraction of the area of the display device, thereby enabling the relatively small number of highly relevant items to be displayed non-intrusively with the simultaneously displayed television content.

22. The system of claim 21, wherein the item is an action for initiating an exchange of information with an entity associated with the action, the descriptive terms associated with the action characterizing the entity associated with the action, and the incremental text inputs incrementally identifying desired actions or associated entities.

23. The system of claim 22, wherein the action is a telephone call placed to the associated entity.

24. The system of claim 23, further comprising connection logic for placing the telephone call to the associated entity and connecting the telephone call to a telephone system proximate to the user.

25. The system of claim 22, wherein the action is a purchase of an article from the associated entity.

26. The system of claim 22, wherein the presentation logic displays on said portion of the display device visual cues to inform the user of the availability of actions for instant and deferred performance.

27. The system of claim 21, wherein the relevance function includes at least one of temporal relevance to compare the time of day to a known time of availability of the item and a popularity relevance to specify a general popularity rating for the item.

28. The system of claim 21, further comprising an action receiving logic for receiving from the user a selection action of one of the ordered results displayed on said portion of the display device.

29. The system of claim 28, further comprising an action performing logic for performing the selection action, wherein the selection action comprises tuning to a television channel or retrieving the selected item from a content source.

30. The system of claim 29, wherein the content source comprises a video-on-demand system, an IPTV system, or a personal video recorder.

31. The system of claim 28, further comprising an action performing logic for performing the selection action, wherein the selection action comprises recording a selected television content item, reminding the user when a selected television content item is broadcasted, finding a related television content item, or retrieving the selected television content item from a content source.

32. The system of claim 28, further comprising an action performing logic for performing the selection action and automatically fetching and presenting a selected television content item or tuning to a selected television channel.

33. The system of claim 21, further comprising logic for selecting and offering to the user an alternative item when the user is unable to find a desired item.

34. The system of claim 21, wherein the display device displays on said portion of the display device visual cues to inform the user of the availability of television content for instant and deferred viewing.

35. The system of claim 21, wherein said portion of the display device is overlaid on television content currently playing on the display device.

36. The system of claim 35, wherein said portion of the display device includes at least parts thereof that are translucent, thereby allowing said television content currently playing on the display device to be at least partially visible to the user through said portion of the display device.

37. The system of claim 21, wherein said portion of the display device includes a field for entry of at least one of the incremental text inputs and a window for displaying a given number of the set of selected items.

38. The system of claim 21, further comprising logic for filtering the set of selected items in accordance with a source or category of the items and displaying filtered items in said portion of the display device.

39. The system of claim 21, wherein the display device further provides to the user through said portion of the display device information related to the selected items.

40. The system of claim 21, wherein the display device is included in or proximate to a television set.

41. The system of claim 21, wherein at least one of the receiving logic, the monitoring logic, the learning logic, the first selection logic, the second selection logic, the ordering logic, and the presentation logic is executed on a server system remote from the user in communication with the display device over a network.

42. The system of claim 21, further comprising display logic on the display device for enabling the user to scroll through additional items of the selected set by displaying identification of the additional items when directed by the user.

43. The system of claim 21, wherein the user enters at least one of the incremental text inputs on a remote control device having keys overloaded with two or more characters.
